(19) United States
(12) Patent Application Publication
(10) Pub. No.: US 2026/0111058 A1
(43) Pub. Date: Apr. 23, 2026

(54) DETECTION DEVICE

(71) Applicant: Japan Display Inc., Tokyo (JP)

(72) Inventor: Yoshitaka KOJIMA, Tokyo (JP)

(21) Appl. No.: 19/429,144

(22) Filed: Dec. 22, 2025

Related U.S. Application Data
(63) Continuation of application No. PCT/JP2024/018802, filed on May 22, 2024.

(30) Foreign Application Priority Data
Jun. 26, 2023 (JP) 2023-104497

(51) Int. Cl. G06F 1/16; G06F 3/01

(52) U.S. Cl. CPC G06F 1/163; G06F 1/1694; G06F 1/1698; G06F 3/014

(57) ABSTRACT

According to an aspect, a detection device includes: a light source, an optical sensor, and a detection circuit. The optical sensor includes a first optical sensor and a second optical sensor located farther from the light source than the first optical sensor is. The light source includes a first light source capable of emitting visible light, a second light source capable of emitting near-infrared light or infrared light, and a third light source capable of emitting visible light different from that of the first light source. The first optical sensor is coupled to the detection circuit when the first and second light sources are off and the third light source is on. At least one of the first optical sensor or the second optical sensor is coupled to the detection circuit when the third light source is off and the first light source or the second light source is on.

### CROSS-REFERENCE TO RELATED APPLICATION

This application claims the benefit of priority from Japanese Patent Application No. 2023-104497 filed on Jun. 26, 2023 and International Patent Application No. PCT/JP2024/018802 filed on May 22, 2024, the entire contents of which are incorporated herein by reference.

### BACKGROUND

### 1. Technical Field

What is disclosed herein relates to a detection device.

### 2. Description of the Related Art

Optical sensors capable of detecting fingerprint patterns and vascular patterns are known (for example, WO 2020/213621). In an optical sensor described in WO 2020/213621, a plurality of pixels may be collectively driven by simultaneously selecting a plurality of signal lines.

When a detection device is worn on a human body to perform detection, appropriate detection results may not be obtained if the distance from a detecting portion to the human body is large. The detection devices worn on the human body may have small battery capacities and are required to reduce power consumption.

For the foregoing reasons, there is a need for a detection device that can obtain appropriate detection results and reduce power consumption.

### SUMMARY

According to an aspect, a detection device includes: a light source capable of emitting light in a plurality of colors having wavelengths different from one another to one finger wearing the detection device; an optical sensor configured to receive light from the finger and output a signal corresponding to the light; and a detection circuit configured to perform signal processing based on the signal output from the optical sensor. The optical sensor includes a first optical sensor and a second optical sensor that is located in a position farther in distance from the light source than the first optical sensor is. The light source, the first optical sensor, and the second optical sensor are arranged in order of the light source, the first optical sensor, and the second optical sensor. The light source includes a first light source capable of emitting visible light, a second light source capable of emitting near-infrared light or infrared light, and a third light source capable of emitting visible light different from the visible light of the first light source. The first optical sensor is configured to be coupled to the detection circuit during a first emission period in which the first light source and the second light source do not emit light and the third light source emits light. The first optical sensor and the second optical sensor are configured such that at least one of the first optical sensor or the second optical sensor is coupled to the detection circuit during a second emission period in which the third light source does not emit light and the first light source or the second light source emits light.

### BRIEF DESCRIPTION OF THE DRAWINGS

FIG. 1 is an external view illustrating a detection device according to an embodiment of the present disclosure;

FIG. 2 is a diagram explaining distances between a light source and an optical sensor;

FIG. 3 is a view illustrating a case of irradiating a finger with green light;

FIG. 4 is a view illustrating a case of irradiating the finger with near-infrared light or red light;

FIG. 5 is a table explaining whether each of reflected light of green light, near-infrared light, and red light reaches optical sensor areas;

FIG. 6 is a block diagram illustrating an internal configuration example of the detection device;

FIG. 7 is a diagram illustrating functions performed by the various parts in the detection device;

FIG. 8 is a diagram illustrating a circuit configuration example of the optical sensor areas;

FIG. 9 is a waveform diagram explaining an operation example in a case of measuring a pulse wave using the detection device;

FIG. 10 is a flowchart illustrating an example of a process to measure the pulse wave using the detection device;

FIG. 11 is a waveform diagram explaining an operation example in a case of measuring SpO₂ using the detection device;

FIG. 12 is a flowchart illustrating an example of a process to measure SpO₂ using the detection device;

FIG. 13 is a diagram illustrating examples of values of SpO₂; and

FIG. 14 is a flowchart illustrating how to measure a blood oxygen level using the detection device.

### DETAILED DESCRIPTION

The following describes a mode (embodiment) for carrying out the disclosure in detail with reference to the drawings. The present disclosure is not limited to the description of the embodiment given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present specification and the drawings, and detailed description thereof may not be repeated where appropriate.

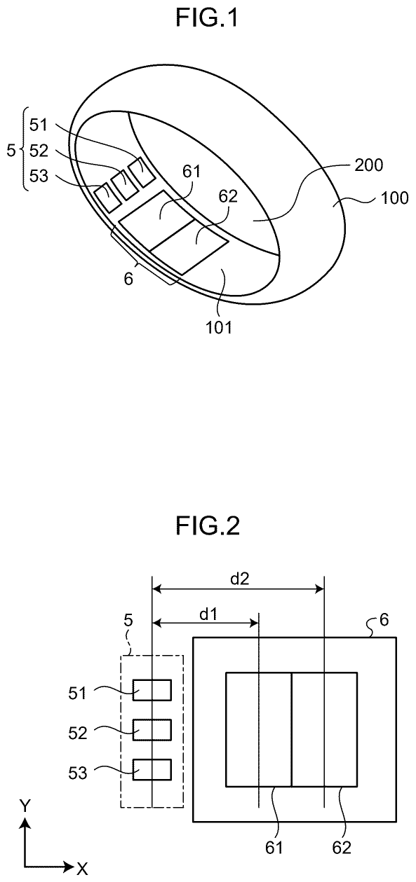

FIG. 1 is an external view illustrating a detection device according to an embodiment of the present disclosure. In FIG. 1, a detection device 100 has a shape of a finger ring. The detection device 100 has a hollow portion 200. The hollow portion 200 of the detection device 100 allows a finger to be inserted thereinto. That is, the detection device 100 has a finger ring-shaped housing. A user of the detection device 100 can wear the detection device 100 on one finger.

In FIG. 1, an inner surface 101 of the detection device 100 is provided with a light source 5 and an optical sensor 6. That is, the light source 5 and the optical sensor 6 are accommodated in the finger ring-shaped housing of the detection device 100. The light source 5 can emit light toward the hollow portion 200. When a finger is inserted in the hollow portion 200, the finger can be irradiated with light emitted from the light source 5.

The light source 5 is a light source that can emit light in a plurality of colors having different wavelengths from one another. The light source 5 includes a light source 51 that can emit red light, a light source 52 that can emit near-infrared light, and a light source 53 that can emit green light. The light source 51 is a red light-emitting diode (LED), for example. The light source 52 is a near-infrared LED, for example. The light source 53 is a green LED, for example. The red light and the green light are visible light. The near-infrared light is not visible light. An infrared light source may be used instead of the light source 52 that is a near-infrared light source. That is, at least one of the near-infrared light source and the infrared light source is used. The light source 51 corresponds to a “first light source” of the present disclosure. The light source 52 corresponds to a “second light source” of the present disclosure. The light source 53 corresponds to a “third light source” of the present disclosure.

The optical sensor 6 is an organic photodiode (OPD), for example, and outputs an electrical signal corresponding to the light emitted thereto. The optical sensor 6 has an optical sensor area 61 and an optical sensor area 62. Focusing on the light source 5 and the optical sensor areas 61 and 62, the light source 5, the optical sensor area 61, and the optical sensor area 62 are arranged in this order on the inner surface 101. The optical sensor area 61 corresponds to a “first optical sensor” of the present disclosure. The optical sensor area 62 corresponds to a “second optical sensor” of the present disclosure.

FIG. 2 is a diagram explaining distances between the light source 5 and the optical sensor 6. In FIG. 2, an X direction is a circumferential direction along the inner circumferential surface of the finger-ring shape. A Y direction is a direction orthogonal to the X direction.

As illustrated in FIG. 2, the optical sensor area 61 and the optical sensor area 62 differ from each other in distance from the light source 5. The optical sensor area 61 is located in a position closer in distance from the light source 5 than the optical sensor area 62 is. The optical sensor area 62 is located in a position farther in distance from the light source 5 than the optical sensor area 61 is. A distance d1 denotes a distance in the X direction from the center position of the light source 5 to the center position of the optical sensor area 61. A distance d2 denotes a distance in the X direction from the center position of the light source 5 to the center position of the optical sensor area 62. The distance d1 is smaller than the distance d2. The distance d2 is longer than the distance d1.

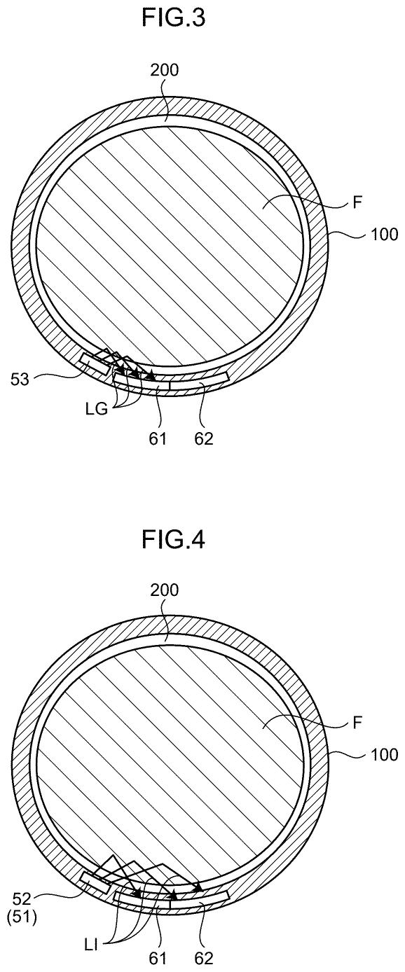

FIGS. 3 and 4 are sectional views each illustrating a state in which the detection device 100 is worn on the finger of the user of the detection device 100.

FIG. 3 is a view illustrating a case of irradiating the finger with the green light. The green light is emitted toward a finger F from the light source 53 of the green light provided on the inner surface of the detection device 100. The green light is reflected by a surface layer near the surface of the finger F. As a result, reflected light LG from the finger F corresponding to the green light reaches an area of the optical sensor 6 closer to the light source 53, that is, the optical sensor area 61 closer in distance from the light source 53. Therefore, the reflected light LG of the green light is detected by the optical sensor area 61.

The reflected light LG of the green light does not, however, reach areas far from the light source 53, that is, areas farther in distance from the light source 53. Therefore, the reflected light LG of the green light is not detected by the optical sensor area 62.

FIG. 4 is a view illustrating a case of irradiating the finger with the near-infrared light or the red light. The near-infrared light is emitted toward the finger F from the light source 52 of the near-infrared light located on the inner surface of the detection device 100. The near-infrared light is reflected at a location deeper than the surface layer of the finger F. As a result, reflected light LI from the finger F corresponding to the near-infrared light reaches an area closer to the light source 52 of the optical sensor 6, that is, the optical sensor area 61 closer in distance from the light source 52. Therefore, the reflected light LI of the near-infrared light is detected by the optical sensor area 61.

The reflected light LI of the near-infrared light also reaches an area of the optical sensor 6 farther from the light source 52, that is, the optical sensor area 62 farther in distance from the light source 52. Therefore, the reflected LI of the near-infrared light is also detected by the optical sensor area 62.

The same as the case of FIG. 4 is also true for the light source 51 of the red light. That is, the reflected light from the finger F corresponding to the red light is reflected at a location deeper than the surface layer of the finger F, and therefore, reaches the optical sensor areas 61 and 62 and is detected by these areas.

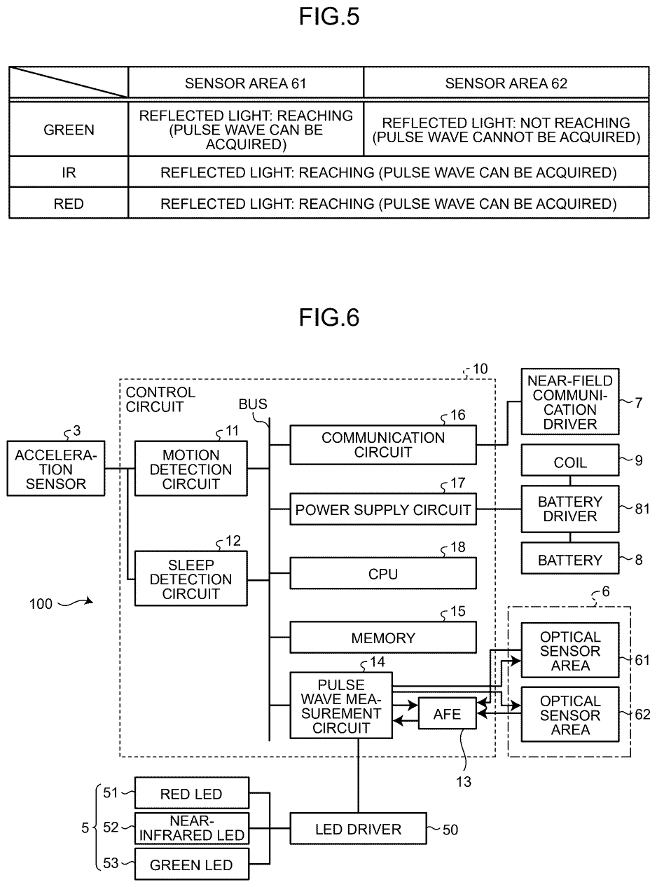

FIG. 5 is a table explaining whether each of the reflected light of the green light, the near-infrared light, and the red light reaches the optical sensor areas. As described with reference to FIGS. 3 and 4, the depth of light penetration into the living body varies depending on the emission color.

The green light (GREEN) is reflected by the surface layer near the surface of the finger F. The reflected light of the green light reaches the optical sensor area 61. Therefore, a pulse wave can be acquired using a detection signal of the optical sensor area 61. In contrast, the reflected light of the green light does not reach the optical sensor area 62. Therefore, the pulse wave cannot be acquired using the detection signal of the optical sensor area 62.

The near-infrared light (IR) and the red light (RED) are reflected at the locations deeper than the surface layer of the finger F. The reflected light of the near-infrared light and the red light reaches both the optical sensor areas 61 and 62. Therefore, the pulse wave can be acquired using the detection signal of at least one of the optical sensor areas 61 and 62.

FIG. 6 is a block diagram illustrating an internal configuration example of the detection device 100. As illustrated in FIG. 6, the detection device 100 includes an acceleration sensor 3, the light source 5, an LED driver 50, the optical sensor 6, a near-field communication driver 7, a battery 8, a coil 9, a battery driver 81, and a control circuit 10.

The acceleration sensor 3 detects acceleration applied to the detection device 100. A detection value of the acceleration applied to the detection device 100 is used to determine the state of a wearer of the detection device 100, as described below. The acceleration sensor 3 is a triaxial acceleration sensor, for example.

The light source 5 includes the light sources 51, 52, and 53. In this example, the light source 51 is the red LED, the light source 52 is the near-infrared LED, and the light source 53 is the green LED. Hereinafter, the light source 51 will be referred to as a “red LED 51”, the light source 52 as a “near-infrared LED 52”, and the light source 53 as a “green LED 53”. The LED driver 50 drives the red LED 51, the near-infrared LED 52, and the green LED 53 to turn them on.

The optical sensor 6 includes the optical sensor areas 61 and 62. The optical sensor areas 61 and 62 convert incoming light into electrical signals. The optical sensor area 61 and an optical sensor area 62 operate independently of each other.

The near-field communication driver 7 includes an antenna, which is not illustrated. The near-field communication driver 7 exchanges signals between the detection device 100 and other devices. The near-field communication driver 7 can transmit data and the like measured by various parts of the detection device 100 to the other devices. The near-field communication driver 7 can also receive data and the like transmitted from the other devices.

The battery 8 supplies power to various parts of the detection device 100. The battery 8 is a lithium-ion battery, for example. The battery driver 81 controls the battery 8. The battery 8 is charged by the battery driver 81.

The coil 9 is a coil for charging the battery 8. The coil 9 includes windings wound along the housing of the detection device 100. An induced current based on an applied magnetic field flows in the coil 9. The induced current flowing in the coil 9 can charge the battery 8.

The control circuit 10 controls various parts of the detection device 100. The control circuit 10 is an integrated circuit (IC), such as a microcontroller. The control circuit 10 may be, for example, a programmable logic device (PLD) such as a field-programmable gate array (FPGA).

The control circuit 10 includes a motion detection circuit 11, a sleep detection circuit 12, an analog front end (AFE) 13, a pulse wave measurement circuit 14, a memory 15, a communication circuit 16, a power supply circuit 17, and a central processing unit (CPU) 18. These components are coupled by a bus Bus, and can exchange data with each other via the bus Bus.

The motion detection circuit 11 detects a moving state and a still state of the user of the detection device 100 based on outputs of the acceleration sensor 3. The sleep detection circuit 12 detects an asleep state and an awake state of the user of the detection device 100 based on the outputs of the acceleration sensor 3 and measurement results by the pulse wave measurement circuit 14.

The pulse wave measurement circuit 14 is coupled to the LED driver 50, the AFE 13, and the optical sensor 6. The pulse wave measurement circuit 14 measures a pulse frequency, a blood oxygen level, and the like based on detection data of the optical sensor 6. The pulse wave measurement circuit 14 measures a change over time of a detection value of the optical sensor 6, as the pulse wave.

The memory 15 is a storage that stores therein various types of data. The memory 15 may include, as an aspect, for example, a random-access memory (RAM), a read-only memory (ROM), an electrically erasable programmable read-only memory (EEPROM), and/or the like.

The communication circuit 16 is coupled to the near-field communication driver 7. The communication circuit 16 transmits measurement results and so forth to an external device. The external device is, for example, a terminal device such as a smartphone or a tablet computer held by the user of the detection device 100. The terminal device such as the smartphone or the tablet computer includes a display screen. By displaying data from the detection device 100 on the screen, the user of the detection device 100 can check the data received from the detection device 100.

The power supply circuit 17 is coupled to the battery driver 81. The power supply circuit 17 controls the charging of the battery 8 and supplies the power from the battery 8 to the various parts.

The CPU 18 is a controller that controls various parts in the control circuit 10. The CPU 18 measures or calculates biometric information, such as a pulse wave velocity, blood pressure, and the pulse frequency, by executing predetermined programs.

### Functions of Various Parts of Detection Device

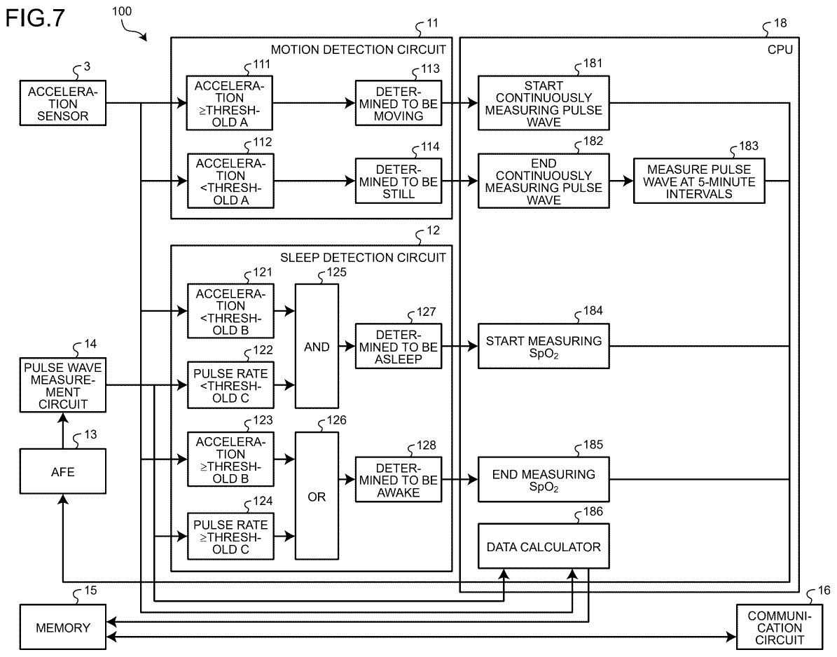

FIG. 7 is a diagram illustrating functions performed by the various parts in the detection device 100. As illustrated in FIG. 7, the motion detection circuit 11 implements determiners 111 to 114. The determiners 111 and 112 receive the acceleration acquired by the acceleration sensor 3.

The determiner 111 determines whether the acceleration acquired by the acceleration sensor 3 is equal to or higher than a predetermined threshold A. If the determiner 111 determines that the acceleration is equal to or higher than the predetermined threshold A, the determiner 113 determines that the user of the detection device 100 is in the moving state.

The determiner 112 determines that the acceleration acquired by the acceleration sensor 3 is lower than the predetermined threshold A. If the determiner 112 determines that the acceleration acquired by the acceleration sensor 3 is lower than the predetermined threshold A, the determiner 114 determines that the user of the detection device 100 is in the still state.

The sleep detection circuit 12 implements determiners 121 to 128. The determiners 121 and 123 receive the acceleration acquired by the acceleration sensor 3. The determiners 122 and 124 receive a pulse rate based on the pulse wave measured by the pulse wave measurement circuit 14.

The determiner 121 determines whether the acceleration acquired by the acceleration sensor 3 is lower than a predetermined threshold B. The determiner 122 determines whether the pulse rate received from the pulse wave measurement circuit 14 is less than a predetermined threshold C. The determiner 125 performs a determination on the logical product (AND) between the determination result of the determiner 121 and the determination result of the determiner 122.

The determiner 127 determines the asleep state of the user of the detection device 100 based on the result of the determination by the determiner 125. If, as a result of the determination by the determiner 125, the acceleration acquired by the acceleration sensor 3 is lower than the threshold B and the pulse rate received from the pulse wave measurement circuit 14 is lower than the threshold C, the determiner 127 determines that the user of the detection device 100 is in the asleep state.

The determiner 123 determines whether the acceleration acquired by the acceleration sensor 3 is equal to or higher than the predetermined threshold B. The determiner 124 determines whether the pulse rate received from the pulse wave measurement circuit 14 is equal to or higher than the predetermined threshold C. The determiner 126 performs a determination on the logical sum (OR) between the determination result of the determiner 123 and the determination result of the determiner 124.

The determiner 128 determines the awake state of the user of the detection device 100 based on the result of the determination by the determiner 126. If, as a result of the determination by the determiner 126, the acceleration acquired by the acceleration sensor 3 is equal to or higher than the threshold B, or the pulse rate received from the pulse wave measurement circuit 14 is equal to or higher than the threshold C, the determiner 128 determines that the user of the detection device 100 is in the awake state.

The CPU 18 implements determiners 181 to 185 and a data calculator 186. The determiner 181 determines, based on the detection result of the motion detection circuit 11, whether to start continuous measurement of the pulse wave. If the motion detection circuit 11 determines that the user of the detection device 100 is in the moving state, the determiner 181 determines that continuous pulse wave measurement is to be started. That is, signal processing of the pulse wave is performed if the acceleration acquired by the acceleration sensor 3 is equal to or higher than the threshold A.

The determiner 182 determines, based on the detection result of the motion detection circuit 11, whether to end the continuous measurement of the pulse wave. If the motion detection circuit 11 determines that the user of the detection device 100 is in the still state, the determiner 182 determines that the continuous measurement of the pulse wave is to be ended. If the determiner 182 determines that the continuous measurement of the pulse wave is to be ended, the determiner 183 determines that the pulse wave is to be measured at predetermined time intervals. For example, the determiner 183 determines that the pulse wave is to be measured at intervals of 5 minutes.

The determiner 184 determines, based on the detection result of the sleep detection circuit 12, whether to start measurement of a blood oxygen saturation level SpO₂. If the sleep detection circuit 12 determines that the user of the detection device 100 is in the asleep state, the determiner 184 determines that the measurement of the blood oxygen saturation level SpO₂ is to be started. That is, the measurement of the blood oxygen saturation level SpO₂ is started, if the acceleration acquired by the acceleration sensor 3 is lower than the threshold B and the pulse rate received from the pulse wave measurement circuit 14 is lower than the threshold C.

The determiner 185 determines, based on the detection result of the sleep detection circuit 12, whether to end the measurement of the blood oxygen saturation level SpO₂. If the sleep detection circuit 12 determines that the user of the detection device 100 is in the awake state, the determiner 185 determines that the measurement of the blood oxygen saturation level SpO₂ is to be ended.

The data calculator 186 receives, as input, the acceleration acquired by the acceleration sensor 3 and the pulse rate from the pulse wave measurement circuit 14. The data calculator 186 calculates the various types of data. The data of the result of the calculation by the data calculator 186 is stored in the memory 15. The memory 15 stores therein, for example, the data of the measured pulse rate and the data of the measured blood oxygen saturation level.

### Optical Sensor Areas

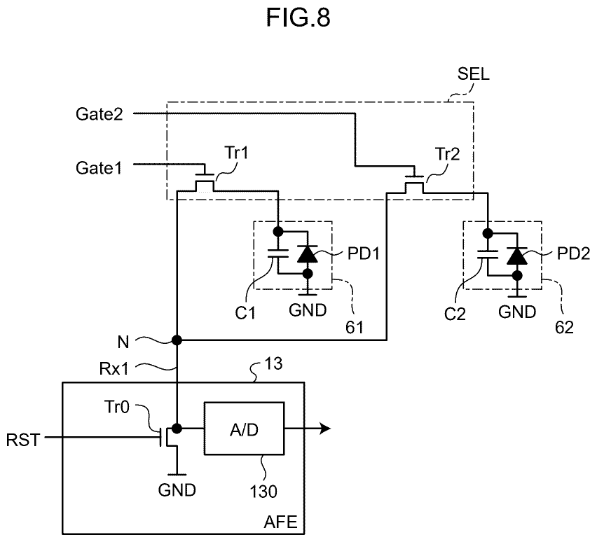

FIG. 8 is a diagram illustrating a circuit configuration example of the optical sensor areas. As illustrated in FIG. 8, the optical sensor area 61 includes a photodiode PD1 and a capacitive element C1. The optical sensor area 62 includes a photodiode PD2 and a capacitive element C2. An output signal of the optical sensor area 61 and an output signal of the optical sensor area 62 are received by a selection circuit SEL. The selection circuit SEL includes a switching element Tr1 and a switching element Tr2.

The photodiode PD1 outputs a current corresponding to the incoming light, and an electric charge based on this current is accumulated in the capacitive element C1. The photodiode PD2 outputs a current corresponding to the incoming light, and an electric charge based on this current is accumulated in the capacitive element C2.

The switching element Tr1 of the selection circuit SEL is provided correspondingly to the photodiode PD1. A gate signal Gate1 is applied to the gate terminal of the switching element Tr1. When the gate signal Gate1 is at a low level, the switching element Tr1 is in the off state, and the electric charge is accumulated in the capacitive element C1 as described above. When the gate signal Gate1 is at a high level, the switching element Tr1 is in the on state, and a current based on the electric charge stored in the capacitive element C1 is output.

The switching element Tr2 of the selection circuit SEL is provided correspondingly to the photodiode PD2. A gate signal Gate2 is applied to the gate terminal of switching element Tr2. When the gate signal Gate2 is at the low level, the switching element Tr2 is in the off state, and the electric charge is accumulated in the capacitive element C2 as described above. When the gate signal Gate2 is at the high level, the switching element Tr2 is in the on state, and a current based on the electric charge stored in the capacitive element C2 is output.

That is, the selection circuit SEL selects and outputs the output signals of the optical sensor areas 61 and 62 based on the levels of the gate signals Gate1 and Gate2. A signal passing through the switching element Tr1 from the optical sensor area 61 and a signal passing through the switching element Tr2 from the optical sensor area 62 are combined at a coupling point N and supplied as a received light signal Rx1 to the AFE 13.

The switching elements Tr1 and Tr2 are each configured as a thin-film transistor, and in this example, made of an n-channel metal oxide semiconductor (MOS) thin-film transistor (TFT).

The AFE 13 is a detection circuit that performs signal processing based on the signal output from the optical sensor 6. The AFE 13 includes a switching element Tr0 and an analog-to-digital (A/D) conversion circuit 130. A reset signal RST is applied to the gate terminal of a transistor serving as the switching element Tr0. When the reset signal RST is at a low level, the switching element Tr0 is in the off state, and the received light signal Rx1 is supplied to the A/D conversion circuit 130. The A/D conversion circuit 130 outputs data corresponding to the received light signal Rx1. The data output from the A/D conversion circuit 130 is received by the pulse wave measurement circuit 14.

When the reset signal RST is at a high level, the switching element Tr0 is in the on state, and the received light signal Rx1 is not supplied to the A/D conversion circuit 130.

### Measurement of Pulse Wave

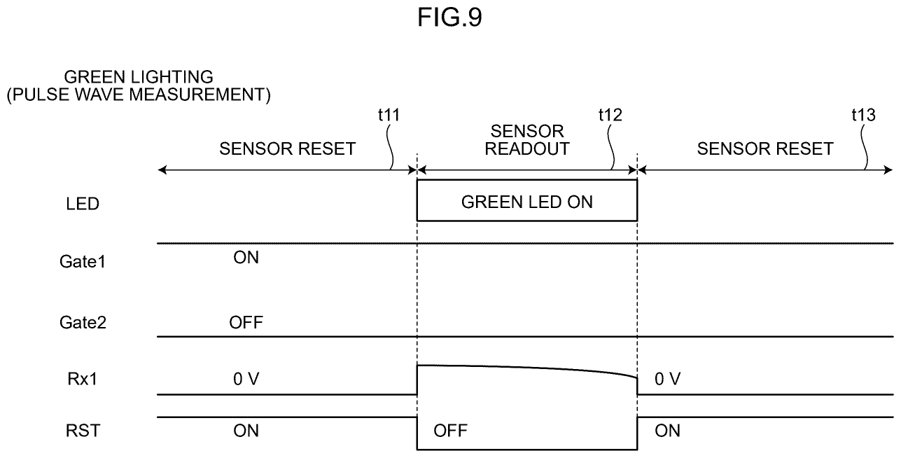

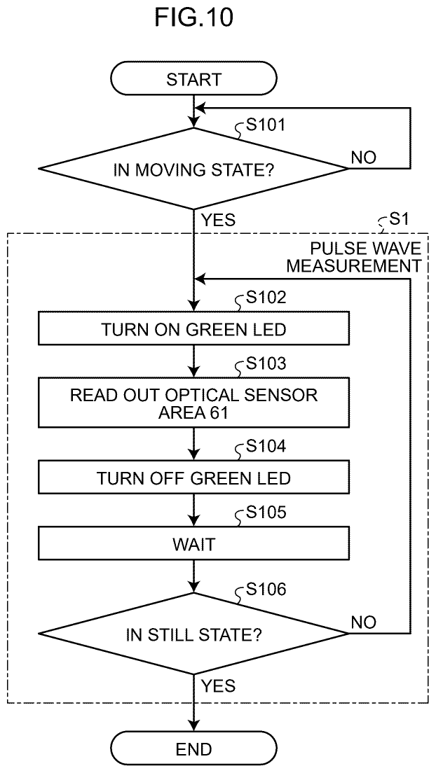

FIGS. 9 and 10 are diagrams explaining an operation when the detection device 100 measures the pulse wave during the moving state. In this example, the green LED 53 is turned on, and the pulse wave is measured.

FIG. 9 is a waveform diagram explaining an operation example in the case of measuring the pulse wave using the detection device 100. FIG. 9 illustrates the lighting state of the LED, the gate signals Gate1 and Gate2, the received light signal Rx1, and the reset signal RST.

As illustrated in FIG. 9, when the detection device 100 measures the pulse wave, sensor reset process of resetting the optical sensor area and sensor readout process of reading out from the optical sensor area are alternately performed.

During a sensor reset period t11, the green LED 53 is not lit. During the period t11, the gate signal Gate1 is at the high level and the gate signal Gate2 is at the low level. As a result, the switching element Tr1 is in the on state, and the switching element Tr2 is in the off state. Since the reset signal RST is at the high level, the switching element Tr0 is in the on state. The received light signal Rx1 is at the ground level, that is, 0 (V). As a result, the electric charges accumulated in the photodiode PD1 and the capacitive element C1 are discharged. The input to the A/D conversion circuit 130 is 0 (V). The period during which the gate signal Gate1 is at the high level may be a part of the sensor reset period t11 as long as being a time sufficient to discharge the electric charges accumulated in the photodiode PD1 and the capacitive element C1.

The green LED 53 is lit during a sensor readout period t12. When the green LED 53 is emitting light, the red LED 51 and the near-infrared LED 52 do not emit light. The period t12 is a first emission period during which the red LED 51 and the near-infrared LED 52 do not emit light and the green LED 53 emits light. During the period t12, the gate signal Gate1 is at the high level and the gate signal Gate2 is at the low level. As a result, the switching element Tr1 is in the on state, and the switching element Tr2 is in the off state. Thus, the received light signal Rx1 obtained by the optical sensor area 61 is output. When the green LED 53 is emitting light, the switching element Tr1 of the selection circuit SEL transmits the output signal of the optical sensor area 61 to the pulse wave measurement circuit 14 via the AFE 13. The pulse wave measurement circuit 14 performs the measurement based on the signal output by the optical sensor area 61. That is, in the period t12, the selection circuit SEL couples the optical sensor area 61 to the AFE 13.

During the sensor readout period t12, the reset signal RST is at the low level, and the switching element Tr0 is in the off state. As a result, the received light signal Rx1 is supplied to the A/D conversion circuit 130. The data (not illustrated) corresponding to the voltage value of the received light signal Rx1 is output from the A/D conversion circuit 130.

During the period t12, the gate signal Gate2 is at the low level, and the optical sensor area 62 is not used. The optical sensor area 62 is not used because the green light from the green LED 53 does not reach the optical sensor area 62 located far from the green LED 53 as described above. During the period t12, the light is received by only the optical sensor area 61 where the green light from the green LED 53 reaches. That is, the light is received by only the optical sensor area 61 that is closer in distance from the green LED 53. During the period t12, the optical sensor area 62 is not used, so that power consumption can be reduced.

In a subsequent sensor reset period t13, the green LED 53 is not lit, and the operation is the same as in the period t11 described above. Since the reset signal RST is at the high level, and the switching element Tr0 is in the on state, the input to the A/D conversion circuit 130 is 0 (V).

FIG. 10 is a flowchart illustrating an example of a process to measure the pulse wave using the detection device 100. FIG. 10 mainly illustrates details of processing by the motion detection circuit 11 and the CPU 18 (refer to FIG. 6). The CPU 18 performs a pulse wave measurement process S1.

In FIG. 10, first, the motion detection circuit 11 determines whether the user of the detection device 100 is in the moving state (Step S101). At Step S101, if it is determined that the user is not in the moving state (No at Step S101), the process waits until the user is determined to be in the moving state.

At Step S101, if it is determined that the user is in the moving state (Yes at Step S101), the green LED 53 is turned on (Step S102). While the green LED 53 is on, the readout of the optical sensor area 61 is performed (Step S103).

After the readout of the optical sensor area 61 is performed, the green LED 53 is turned off (Step S104). Then, following a waiting state (WAIT) of a predetermined time (Step S105), whether the user of the detection device 100 is in the still state is determined (Step S106).

At Step S106, if it is determined that the user is in the still state (Yes at Step S106), the process ends. In contrast, if, at Step S106, it is determined that the user is not in the still state (No at Step S106), the process returns to Step S102, and continues the pulse wave measurement process S1.

### Measurement of SpO₂

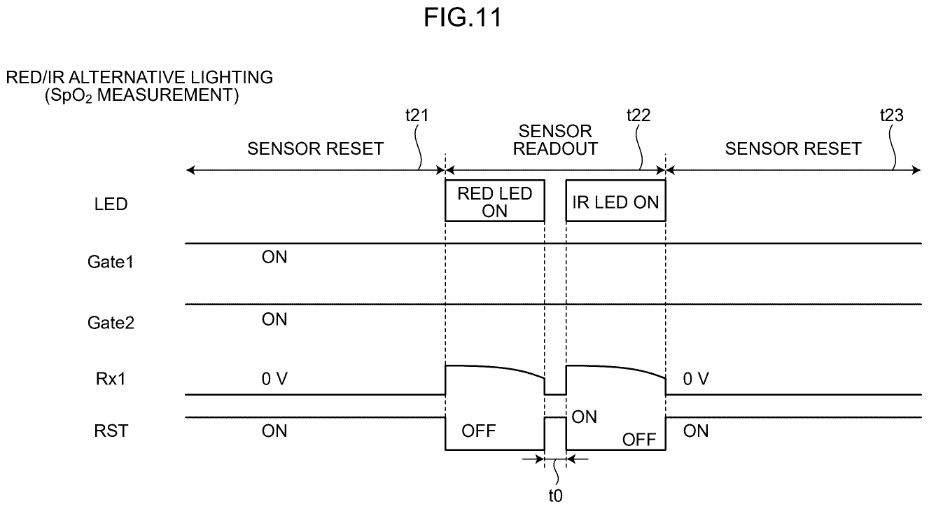

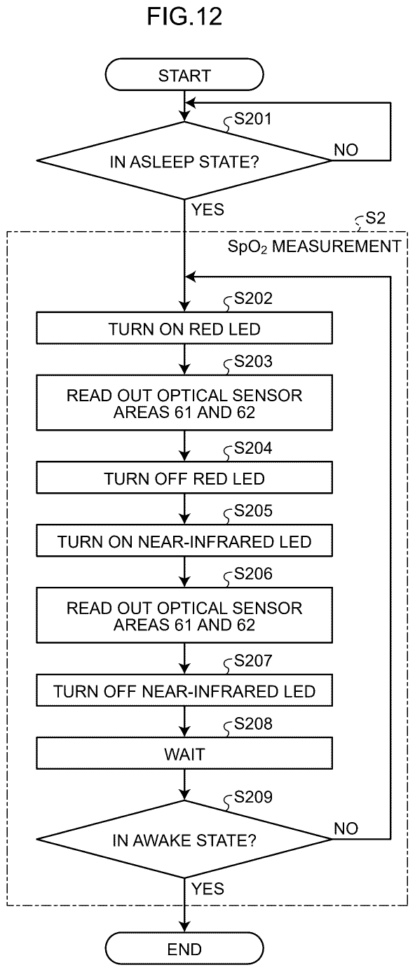

FIGS. 11 and 12 are diagrams explaining an operation when the detection device 100 measures SpO₂. In this example, the red LED 51 and the near-infrared LED 52 are alternately turned on, and SpO₂ is measured.

FIG. 11 is a waveform diagram explaining an operation example in the case of measuring SpO₂ using the detection device 100. FIG. 11 illustrates the lighting states of the LEDs, the gate signals Gate1 and Gate2, the received light signal Rx1, and the reset signal RST.

As illustrated in FIG. 11, when the detection device 100 measures SpO₂, the sensor reset process of resetting the optical sensor areas and the sensor readout process of reading out from the optical sensors area are alternately performed.

During a sensor reset period t21, the red LED 51 and the near-infrared LED 52 are not lit. During the period t21, both the gate signals Gate1 and Gate2 are at the high level, and both the switching elements Tr1 and Tr2 are in the on state. Since the reset signal RST is at the high level, the switching element Tr0 is in the on state. The received light signal Rx1 is at the ground level, that is, 0 (V). As a result, the electric charges accumulated in the photodiodes PD1 and PD2 and the capacitive elements C1 and C2 are discharged. The input to the A/D conversion circuit 130 is 0 (V). The period during which the gate signal Gate1 is at the high level may be a part of the sensor reset period t21 as long as being a time sufficient to discharge the electric charges accumulated in the photodiodes PD1 and PD2 and the capacitive elements C1 and C2.

During a sensor readout period t22, the red LED 51 is on. When the red LED 51 is emitting light, the near-infrared LED 52 and the green LED 53 do not emit light. The red LED 51 is then turned off, and after a non-lighting period to, the near-infrared LED 52 is turned on. The non-lighting period to is a preparatory period for ending the measurement by lighting the red LED 51 and making a transition to the measurement by lighting the near-infrared LED 52. Therefore, the reset signal RST is at the high level during the non-lighting period to. After the non-lighting period to elapses, the reset signal RST returns to the low level. The red LED 51 and the green LED 53 do not emit light when the near-infrared LED 52 is emitting light. The period t22 is a second emission period during which the green LED 53 does not emit light and the red LED 51 or the near-infrared LED 52 emits light.

During the period t22, both the gate signals Gate1 and Gate2 are at the high level. As a result, both the switching elements Tr1 and Tr2 are in the on state. Thus, the received light signal Rx1 obtained by the optical sensor areas 61 and 62 is output. At this time, a voltage value due to the lighting of the red LED 51 is output as the received light signal Rx1 during the first half of the sensor readout period t22. During the second half of the sensor readout period t22, a voltage value due to the lighting of the near-infrared LED 52 is output as the received light signal Rx1. When the red LED 51 or the near-infrared LED 52 is emitting light, the switching elements Tr1 and Tr2 of the selection circuit SEL transmit the output signal of one of the optical sensor areas 61 and 62, which is receiving light, to the pulse wave measurement circuit 14 via the AFE 13. During the period t22, the pulse wave measurement circuit 14 performs the measurement based on a signal output by at least one of the optical sensor areas 61 and 62. That is, in the period t22, the selection circuit SEL couples at least one of the optical sensor areas 61 and 62 to the AFE 13.

During the sensor readout period t22, the reset signal RST changes in the order of the low level, the high level, and the low level. During the non-lighting period to in the sensor readout period t22, the reset signal RST is at the high level, so that the switching element Tr0 is in the on state. The received light signal Rx1 is at the ground level, that is, 0 (V). As a result, the input to the A/D conversion circuit 130 is 0 (V). The data (not illustrated) corresponding to the voltage value of the received light signal Rx1 is output from the A/D conversion circuit 130. In the first half of the sensor readout period t22, data corresponding to a voltage value due to the lighting of the red LED 51 is obtained. In the second half of the sensor readout period t22, data corresponding to a voltage values due to the lighting of the near-infrared LED 52 is obtained. That is, the red LED 51 and the near-infrared LED 52 are alternately turned on, and SpO₂ is measured based on signals obtained by both the optical sensor areas 61 and 62.

In the period t22, unlike in the period t12 in FIG. 9, both the gate signals Gate1 and Gate2 are at the high level, and both the optical sensor areas 61 and 62 are used. That is, both the optical sensor areas 61 and 62 receive light. By enlarging the area for receiving light, the sensitivity of light reception becomes higher and the measurement results obtained can be more accurate than in the case of the period t12 in FIG. 9.

In a subsequent sensor reset period t23, the red LED 51 and the near-infrared LED 52 are not lit, and the operation is the same as in the period t21 described above. Since the reset signal RST is at the high level, and the switching element Tr0 is in the on state, the input to the A/D conversion circuit 130 is 0 (V).

In the example described above, the output signals of both the optical sensor areas 61 and 62 are transmitted via the AFE 13 in the period t22, but the output signal of one of the optical sensor areas 61 and 62 may be transmitted via the AFE 13. That is, when the red LED 51 or the near-infrared LED 52 is emitting light, the output signal of at least one of the optical sensor areas 61 and 62 is transmitted via the AFE 13, without lighting the green LED 53.

FIG. 12 is a flowchart illustrating an example of a process to measure SpO₂ using the detection device 100. FIG. 12 mainly illustrates details of processing by the sleep detection circuit 12 and the CPU 18 (refer to FIG. 6). The CPU 18 performs an SpO₂ measurement process S2.

In FIG. 12, first, the sleep detection circuit 12 determines whether the user of the detection device 100 is in the asleep state (Step S201). If it is determined that the user is not in the asleep state (No at Step S201), the process waits until the user is determined to be in the asleep state.

At Step S201, if it is determined that the user is in the asleep state (Yes at Step S201), the red LED 51 is turned on (Step S202). While the red LED 51 is on, the readout of the optical sensor areas 61 and 62 is performed (Step S203). After the readout of the optical sensor areas 61 and 62 is performed, the red LED 51 is turned off (Step S204).

Then, the near-infrared LED 52 is turned on (Step S205). While the near-infrared LED 52 is on, the readout of the optical sensor areas 61 and 62 is performed (Step S206). After the readout of the optical sensor areas 61 and 62 is performed, the near-infrared LED 52 is turned off (Step S207). Then, following the waiting state (WAIT) of the predetermined time (Step S208), whether the user of the detection device 100 is in the awake state is determined (Step S208).

At Step S209, if it is determined that the user is in the awake state (Yes at Step S209), the process ends. In contrast, if, at Step S209, it is determined that the user is not in the awake state (No at Step S209), the process returns to Step S202, and continues the SpO₂ measurement process S2.

According to the SpO₂ measurement process described with reference to FIG. 12, both the optical sensor areas 61 and 62 are used. As a result, the sensitivity of light reception becomes higher, and more accurate measurement results can be obtained.

### How to Measure Blood Oxygen Level

The blood oxygen level (hereinafter, referred to as SpO₂) that serves as the biometric information can be acquired by measuring light transmitted through the living body, such as a finger. For example, SpO₂ can be measured using Expression (1) below.

$${SpO}_{2} = b - a \cdot R \qquad ( 1 )$$

As given in Expression (1) above, SpO₂ is a linear function of a value R. In Expression (1) given above, “a” and “b” are predetermined coefficients. The value R in Expression (1) is defined by Expression (2) below.

$$R = ( ACr / DCr ) / ( ACir / DCir ) \qquad ( 2 )$$

In Expression (2) given above, ACr denotes the alternating-current (AC) component of a measured value of the red light (Red); DCr denotes the direct-current (DC) component of the measured value of the red light; ACir is the AC component of a measured value of the near-infrared light (IR); and DCir denotes the DC component of the measured value of the near-infrared light. The AC component is a pulse wave component that appears in a DC current. SpO₂, which is the linear function of the value R, is calibrated against an oxygen concentration of blood drawn in advance.

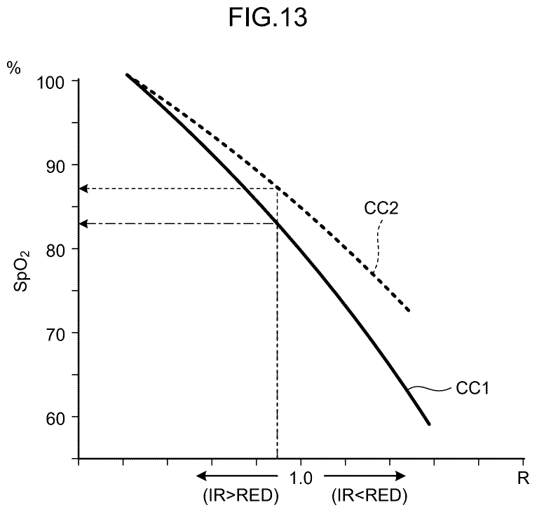

More specifically, the value of SpO₂ can be obtained in the following way. That is, the values of SpO₂ corresponding to the values R described above are measured in advance, and the value of SpO₂ is obtained based on a curve of the measured values. FIG. 13 is a diagram illustrating examples of the values of SpO₂. The curve of the measured values represents calculated values of the above-described value R illustrated in, for example, FIG. 13, and the vertical axis in FIG. 13 represents the value of SpO₂. When Ir light is greater than Red light (Ir>Red), the value R is less than 1.0, and when Red light is greater than Ir light (Ir<Red), the value R is greater than 1.0.

As illustrated in FIG. 13, by calculating the value R described above, the value of SpO₂ corresponding to the value R can be obtained. For example, using a curve CC1 in FIG. 13, the value of SpO₂ of approximately 83% can be obtained when the value R is 0.9. For example, using a curve CC2 in FIG. 13, the value of SpO₂ of approximately 87% can be obtained when the value R is 0.9.

The value of SpO₂ can also be obtained using Expression (1) by determining the above-mentioned coefficients “a” and “b” so as to establish an approximate expression of the curve CC1 or the curve CC2.

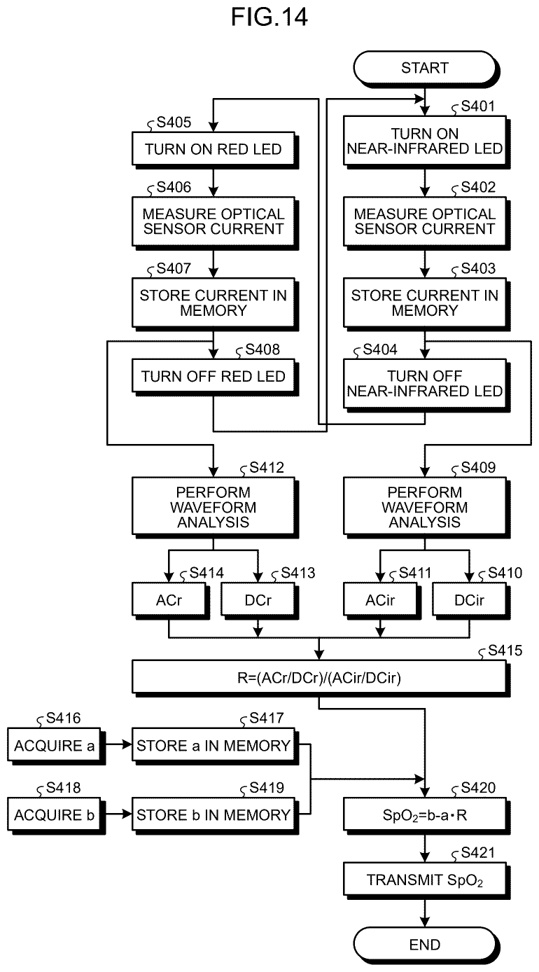

FIG. 14 is a flowchart illustrating how to measure the blood oxygen level using the detection device 100. In FIG. 14, the pulse wave measurement circuit 14 uses the LED driver 50 to turn on the near-infrared LED 52 (Step S401). The pulse wave measurement circuit 14 measures an output current of the optical sensor 6 (Step S402). The measurement result of the current value at Step S402 is stored in the memory 15 (Step S403). The pulse wave measurement circuit 14 uses the LED driver 50 to turn off the near-infrared LED 52 (Step S404).

The pulse wave measurement circuit 14 uses the LED driver 50 to turn on the red LED 51 (Step S405). The pulse wave measurement circuit 14 measures the output current of the optical sensor 6 (Step S406). The measurement result of the current value at Step S406 is stored in the memory 15 (Step S407). The pulse wave measurement circuit 14 uses the LED driver 50 to turn off the red LED 51 (Step S408). The process returns to Step S401, and the pulse wave measurement circuit 14 repeats the processes described above. That is, the pulse wave measurement circuit 14 alternately lights the red LED 51 and the near-infrared LED 52, repeatedly measures the optical sensor current using the optical sensor 6, and stores the measurement results in the memory 15. As described above, before turning on the red LED 51 and before turning on the near-infrared LED 52, the corresponding photodiodes are reset.

In the control circuit 10, waveform analysis is performed on the measurement results of the output current of the optical sensor 6 caused by the lighting of the near-infrared LED 52, which are stored in the memory 15 (Step S409). Through this waveform analysis, the average value (DCir) and the amplitude (ACir) of the near-infrared signal waveform are calculated (Steps S410 and S411).

In the control circuit 10, the waveform analysis is performed on the measurement results of the output current of the optical sensor 6 caused by the lighting of the red LED 51, which are stored in the memory 15 (Step S412). Through this waveform analysis, the average value (DCr) and the amplitude (ACr) of the red signal waveform are calculated (Steps S413 and S414).

The control circuit 10 then calculates the value R for calculating the blood oxygen saturation level SpO₂ (Step S415). The coefficient “a” for calculating the blood oxygen saturation level SpO₂ is input in advance (Step S416) and stored in the memory 15 (Step S417). The coefficient “b” for calculating the blood oxygen saturation level SpO₂ is also input in advance (Step S418) and stored in the memory 15 (Step S419). The control circuit 10 calculates the blood oxygen saturation level SpO₂ based on Expression (1) given above (Step S420).

The SpO₂ obtained by the processes described above is transmitted to the other devices by the communication circuit 16 and the near-field communication driver 7 (Step S421). The SpO₂ is transmitted to the smartphone, for example. In this example, the transmission from the detection device 100 to the other devices is performed by near-field communication.

What is claimed is:

1. A detection device comprising:
a light source capable of emitting light in a plurality of colors having wavelengths different from one another to one finger wearing the detection device;
an optical sensor configured to receive light from the finger and output a signal corresponding to the light; and
a detection circuit configured to perform signal processing based on the signal output from the optical sensor, wherein
the optical sensor comprises a first optical sensor and a second optical sensor that is located in a position farther in distance from the light source than the first optical sensor is,
the light source, the first optical sensor, and the second optical sensor are arranged in order of the light source, the first optical sensor, and the second optical sensor,
the light source comprises a first light source capable of emitting visible light, a second light source capable of emitting near-infrared light or infrared light, and a third light source capable of emitting visible light different from the visible light of the first light source,
the first optical sensor is configured to be coupled to the detection circuit during a first emission period in which the first light source and the second light source do not emit light and the third light source emits light, and
the first optical sensor and the second optical sensor are configured such that at least one of the first optical sensor or the second optical sensor is coupled to the detection circuit during a second emission period in which the third light source does not emit light and the first light source or the second light source emits light.

2. The detection device according to claim 1, wherein the detection circuit is configured to perform the signal processing based on signals output from the first optical sensor and the second optical sensor during the second emission period.

3. The detection device according to claim 1, wherein both the first optical sensor and the second optical sensor are configured to receive light during the second emission period.

4. The detection device according to claim 2, further comprising a pulse wave measurement circuit, wherein
the pulse wave measurement circuit is configured to measure a change over time of a detection value of the optical sensor, as a pulse wave.

5. The detection device according to claim 1, wherein the visible light that the third light source is capable of emitting is green light.

6. The detection device according to claim 3, wherein the first light source and the second light source are configured to alternately emit light, and a blood oxygen saturation level is measured based on signals obtained by both the first optical sensor and the second optical sensor.

7. The detection device according to claim 1, further comprising an acceleration sensor configured to acquire acceleration, wherein signal processing is performed on a pulse wave when the acceleration acquired by the acceleration sensor is equal to or higher than a predetermined threshold.

8. The detection device according to claim 7, wherein a blood oxygen saturation level is measured when the acceleration acquired by the acceleration sensor is lower than the predetermined threshold and a pulse rate is lower than a predetermined threshold.

9. The detection device according to claim 8, further comprising a memory configured to store data of the measured pulse rate and data of the measured blood oxygen saturation level.

10. The detection device according to claim 1, further comprising a selection circuit configured to select the first optical sensor and the second optical sensor, wherein
the selection circuit is configured to:
couple the first sensor to the detection circuit during the first emission period, and
couple at least one of the first optical sensor or the second optical sensor to the detection circuit during the second emission period.

11. The detection device according to claim 1, wherein the first light source, the second light source, the third light source, the first optical sensor, and the second optical sensor are accommodated in a finger ring-shaped housing.
